(19) United States
(12) Patent Application Publication
(10) Pub. No.: US 2014/0081627 A1
(43) Pub. Date: Mar. 20, 2014

(54) METHOD FOR OPTIMIZATION OF MULTIPLE PSYCHOACOUSTIC EFFECTS

(71) Applicants: Ed Rocha, Mesa, AZ (US); James Steele, Chandler, AZ (US); Justin Allen, Mesa, AZ (US)

(72) Inventors: Ed Rocha, Mesa, AZ (US); James Steele, Chandler, AZ (US); Justin Allen, Mesa, AZ (US)

(73) Assignee: QUICKFILTER TECHNOLOGIES, LLC, Allen, TX (US)

(21) Appl. No.: 13/620,664

(22) Filed: Sep. 14, 2012

(51) Int. Cl. G10L 19/00

(52) U.S. Cl. 704/200.1; 704/E19.001

(57) ABSTRACT

A method for optimizing multiple psychoacoustic effects in a sound system includes synthesizing a high-frequency restored version of a input signal; adding the high-frequency restored version of the input signal to the input signal to create a second signal; synthesizing a third signal having enhanced spatialization from the second signal; synthesizing a fourth signal having virtual bass from the second signal; and, adding the third and fourth signals, or second, third and fourth signals, together to create an output signal.

### BACKGROUND

1. Technical Field

This disclosure relates to methods of using multiple psychoacoustic audio effects for synthesizing virtual sound sources and regenerating lost content.

2. Background

Hearing is not a purely mechanical phenomenon of wave propagation, but is also a sensory and perceptual event; in other words, when a person hears something, that something arrives at the ear as a mechanical sound wave traveling through the air, but within the ear it is transformed into neural action potentials. These nerve pulses then travel to the brain where they are perceived. Hence, in many problems in acoustics, such as for audio processing, it is advantageous to take into account not just the mechanics of the environment, but also the fact that both the ear and the brain are involved in a person's listening experience.

The inner ear, for example, does significant signal processing in converting sound waveforms into neural stimuli, so certain differences between waveforms may be imperceptible. Data compression techniques, such as MP3, make use of this fact. In addition, the ear has a nonlinear response to sounds of different intensity levels, this nonlinear response is called loudness. Another effect of the ear's nonlinear response is that sounds that are close in frequency produce phantom beat notes, or intermodulation distortion products. This disclosure concerns methods to optimize the application of multiple psychoacoustic effects to an audio stream.

### DRAWINGS

FIG. 1 is a flow chart depicting processing flow in a first possible embodiment.

FIG. 2 is a flow chart depicting processing flow in a second possible embodiment.

FIG. 3 is a flow chart depicting processing flow in a third possible embodiment.

FIG. 4 is a flow chart depicting processing flow in a fourth preferred embodiment.

FIG. 5 is a flow chart depicting processing flow in a fifth preferred embodiment.

### DESCRIPTION

We disclose methods to achieve optimum audio performance when utilizing multiple psychoacoustic audio effect algorithms that, when used in combination, can enhance or diminish the effects of the other algorithms employed.

When using audio algorithms for regeneration of lost audio content (i.e., MP3 encoding, internet radio), virtual bass algorithms based on the principal of the missing fundamental and spatialization remixing algorithms based on mid/side (common/side) mixing techniques, the optimum combined effect and implementation optimization are equally important.

High Frequency Restoration (HFR, regeneration of lost audio content), Virtual Bass (VB, missing fundamental) and Spatialization (SP, mid/side remixing) should be arranged to both produce the optimum audio output and most efficient implementation. Certain methods of producing these effects are known in the art, but what is needed is a method to obtain to optimum audio output with the most efficient processing implementation.

HFR recreates high frequency content lost as a result of source compression. Directional cues are typically higher frequency related and are therefore key in re-creation of a sense of direction and space. SP algorithms can benefit from this additional high frequency information and therefore should follow HFR algorithms. VB requires access to the full bass bandwidth of the source. SP algorithms can negatively affect bass content by diminishing it Therefore, VB should not proceed or follow SP in the audio flow.

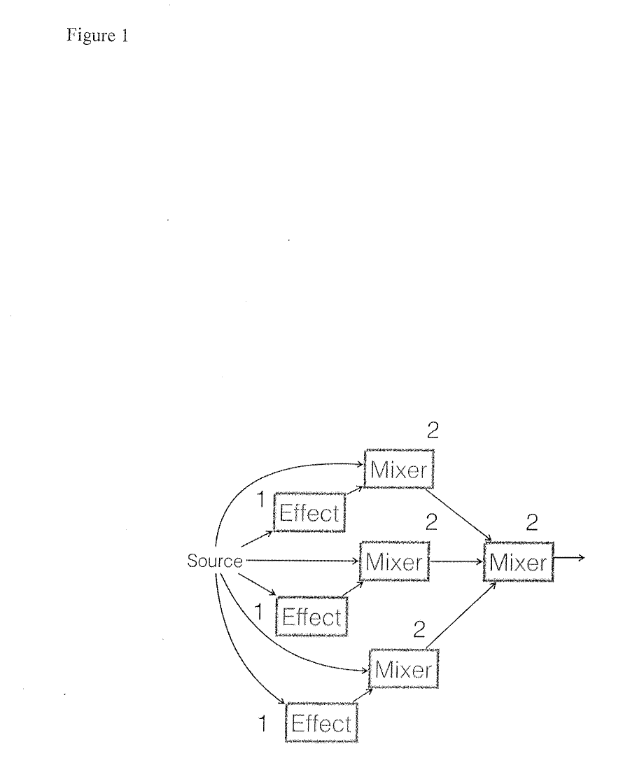

Taking into account all of the above with respect to effect ordering, the most direct implementation is in parallel and is shown in FIG. 1. Each Effect (1) is mixed (2) with the source and all three effects (1) are mixed (2) to create the combined output. The combined output effect is however not optimal, as the SP effect can benefit from the HFR output and the parallel computational requirements to implement FIG. 1 are high. Only one channel is shown in the figures, but of course, the methods disclosed are applicable to stereo systems as well.

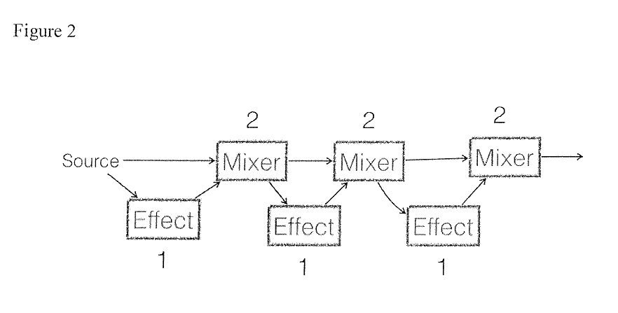

A serial implementation, as shown in FIG. 2, results in lower computational bandwidth and the SP effect can benefit from following the HFR effect but, the VB effect performance is compromised by either preceding or following the SP effect.

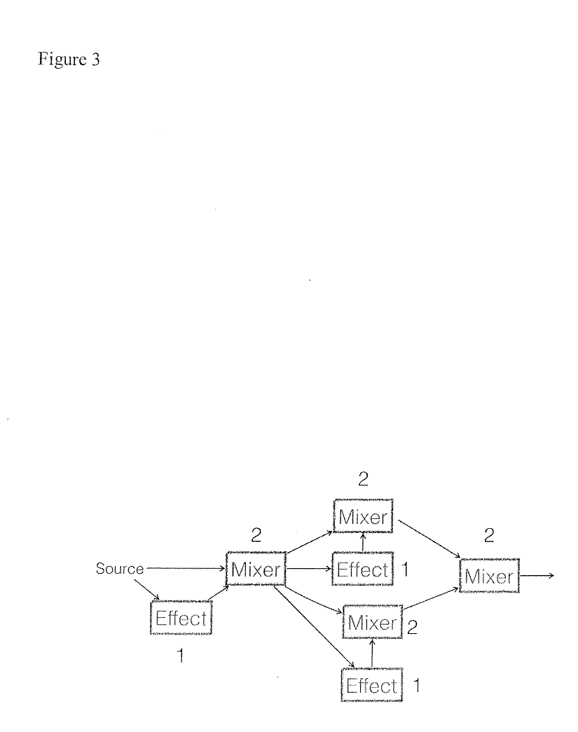

A combination of parallel and serial effect blocks as shown in FIG. 3 overcomes the limitations of FIG. 1 and FIG. 2.

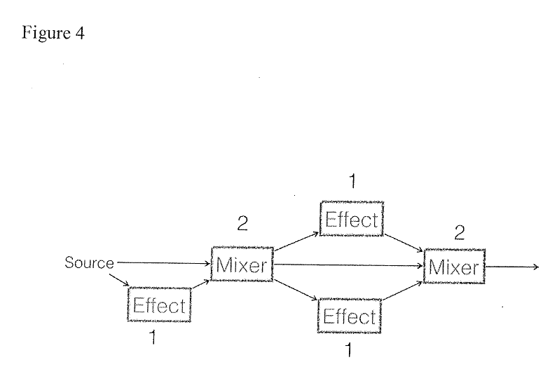

FIG. 3 can be further improved as shown in FIG. 4 resulting in the optimization of the psychoacoustic algorithms, computational bandwidth requirements and implementation.

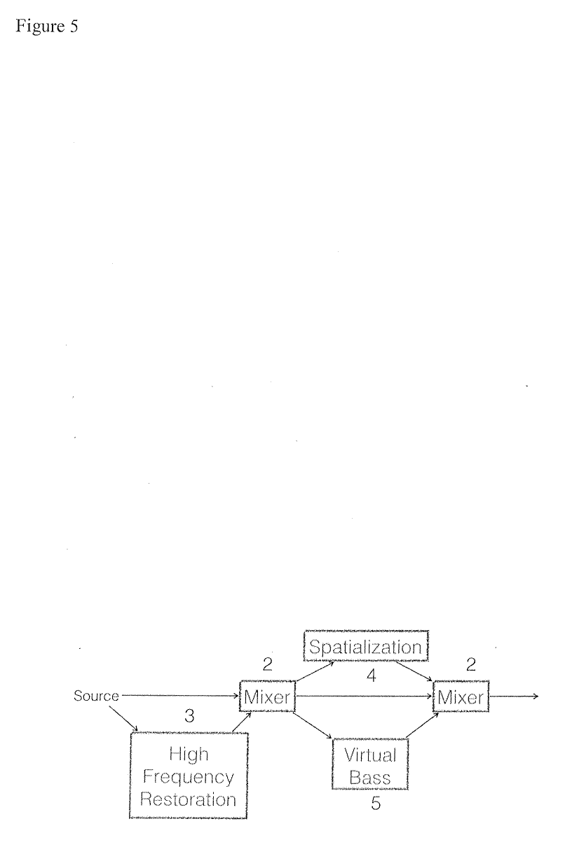

FIG. 5 is the resulting optimized audio flow for HFR, SP and VB psychoacoustic algorithms. The audio source is first processed by the HFR (3) algorithm and mixed (2) back with the source. The additional high frequency content is the passed to both the SP (4) and VB (5) algorithms in parallel. The SP algorithm benefits from the additional high frequency content while the VB benefits from the full source bass content. Both SP and VB are mixed with their source to produce the combined effect output.

The above methods can be implemented on existing digital signal processors, as well as specialized audio processors such as the QF3DFX from Quickfilter Technologies. The methods can also be implemented in an integrated circuit for carrying out the various filtering operations described. In other implementations, the instructions for carrying out the methods can be stored on a computer-readable medium such as magnetic disks, EPROM, ROM, RAM and optical media.

None of the description in this application should be read as implying that any particular element, step, or function is an essential element which must be included in the claim scope; the scope of patented subject matter is defined only by the allowed claims. Moreover, none of these claims are intended to invoke paragraph six of 35 U.S.C. Section 112 unless the exact words “means for” are used, followed by a gerund. The claims as filed are intended to be as comprehensive as possible, and no subject matter is intentionally relinquished, dedicated, or abandoned.

We claim:

1. A method for optimizing multiple psychoacoustic effects in a sound system comprising:
synthesizing a high-frequency restored version of a input signal;
adding the high-frequency restored version of the input signal to the input signal to create a second signal;
synthesizing a third signal having enhanced spatialization from the second signal;
synthesizing a fourth signal having virtual bass from the second signal;
adding the third and fourth signals together to create an output signal.

2. The method of claim 1 where the steps of synthesizing a third signal and synthesizing a fourth signal occur substantially in parallel.

3. A method for optimizing multiple psychoacoustic effects in a sound system comprising the steps of:
synthesizing high-frequency restored version of a input signal;
adding the high-frequency restored version of the input signal to the input signal to create a second signal;
synthesizing a third signal having enhanced spatialization from the second signal;
synthesizing a fourth signal having virtual bass from the second signal;
adding the second, third and fourth signals together to created an output signal.

4. The method of claim 3 where the steps of synthesizing a third signal and synthesizing a fourth signal occur substantially in parallel.

5. A circuit for optimizing multiple psychoacoustic effects in a sound system comprising:
a first circuit for synthesizing a high-frequency restored version of an input signal;
a second circuit connected to the first circuit; the second circuit for adding the high-frequency restored version of the input signal to the input signal to create a second signal;
a third circuit connected to the second circuit; the third circuit for synthesizing a third signal having enhanced spatialization;
a fourth circuit connected to the third circuit; the fourth circuit for synthesizing a fourth signal having virtual bass from the second signal; and, a fifth circuit for adding the third and fourth signals together to create an output signal.

6. A circuit for optimizing multiple psychoacoustic effects in a sound system comprising:
a first circuit for synthesizing a high-frequency restored version of an input signal;
a second circuit connected to the first circuit; the second circuit for adding the high-frequency restored version of the input signal to the input signal to create a second signal;
a third circuit connected to the second circuit; the third circuit for synthesizing a third signal having enhanced spatialization;
a fourth circuit connected to the third circuit; the fourth circuit for synthesizing a fourth signal having virtual bass from the second signal; and,
a fifth circuit for adding the second, third and fourth signals together to create an output signal.

7. A computer-readable medium comprising computer-executable instructions for performing a method comprising:
synthesizing a high-frequency restored version of a input signal;
adding the high-frequency restored version of the input signal to the input signal to create a second signal;
synthesizing a third signal having enhanced spatialization from the second signal;
synthesizing a fourth signal having virtual bass from the second signal;
adding the third and fourth signals together to create an output signal.

8. The computer-readable medium of claim 7 where the steps of synthesizing a third signal and synthesizing a fourth signal occur substantially in parallel.

9. A computer-readable medium comprising computer-executable instructions for optimizing multiple psychoacoustic effects in a sound system, comprising:
synthesizing high-frequency restored version of a input signal;
adding the high-frequency restored version of the input signal to the input signal to create a second signal;
synthesizing a third signal having enhanced spatialization from the second signal;
synthesizing a fourth signal having virtual bass from the second signal;
adding the second, third and fourth signals together to created an output signal.

10. The computer-readable medium of claim 9 where the steps of synthesizing a third signal and synthesizing a fourth signal occur substantially in parallel.
